(19) United States
(12) Patent Application Publication
(10) Pub. No.: US 2024/0378457 A1
(43) Pub. Date: Nov. 14, 2024

(54) SYSTEM AND METHOD FOR STATISTICAL FEDERATED LEARNING

(71) Applicant: Telefonaktiebolaget LM Ericsson (publ), Stockholm (SE)

(72) Inventors: Perepu SATHEESH KUMAR, Chennai (IN); Saravanan M, CHENNAI (IN)

(73) Assignee: Telefonaktiebolaget LM Ericsson (publ), Stockholm (SE)

(21) Appl. No.: 18/686,536

(22) PCT Filed: Aug. 27, 2021
(86) PCT No.: PCT/IN2021/050826

§ 371 Date: Feb. 26, 2024

(51) Int. Cl. G06N 3/098; G06N 3/044; G06N 3/0464

(52) U.S. Cl. CPC G06N 3/098; G06N 3/044; G06N 3/0464

(57) ABSTRACT

A method for distributed machine learning (ML) at a central computing device is provided. The method includes: providing a global ML model to a plurality of local computing devices, wherein the global ML model includes a plurality of parameters; receiving, from each local computing device in a subset of the plurality of local computing devices, a local ML model updated based on the global ML model, wherein the local ML model includes weights with values corresponding to one or more of the plurality of parameters; constructing, for each weight value in each of the received local ML models, a probability distribution for each of the plurality of parameters with corresponding received weight values; sampling, using the constructed probability distribution for each weight value for each of the plurality of parameters, for all of the plurality of local computing devices to generate representative values for each weight; and updating the global ML model by averaging the representative values for each weight for each of the plurality of parameters.

Disclosed are embodiments related to distributed machine learning and, in particular, to systems and methods to statistically extrapolate information in federated learning.

### BACKGROUND

In the past few years, machine learning has led to major breakthroughs in various areas, such as natural language processing, computer vision, speech recognition, and Internet of Things (IoT), with some breakthroughs related to automation and digitalization tasks. Most of this success stems from collecting and processing big data in suitable environments. For some applications of machine learning, this process of collecting data can be incredibly privacy invasive. One potential use case is to improve the results of speech recognition and language translation, while another one is to predict the next word typed on a mobile phone to increase the speed and productivity of the person typing. In both cases, it would be beneficial to directly train on the same data instead of using data from other sources. This would allow for training a machine learning (ML) model (referred to herein as “model” also) on the same data distribution (i.i.d.—independent and identically distributed) that is also used for making predictions. However, directly collecting such data might not always be feasible owing to privacy concerns. Users may not prefer nor have any interest in sending everything they type to a remote server/cloud.

One recent solution to address this is the introduction of federated learning, a new distributed machine learning approach where the training data does not leave the users' computing device at all. Instead of sharing their data directly, the client computing devices themselves compute weight updates using their locally available data. It is a way of training a model without directly inspecting clients' or users' data on a server node or computing device. Federated learning is a collaborative form of machine learning where the training process is distributed among many users. A server node or computing device has the role of coordinating between models, but most of the work is not performed by a central entity anymore but by a federation of users or clients.

After the model is initialized in every user or client computing device, a certain number of devices are randomly selected to improve the model. Each sampled user or client computing device receives the current model from the server node or computing device and uses its locally available data to compute a model update. All these updates are sent back to the server node or computing device where they are averaged, weighted by the number of training examples that the clients used. The server node or computing device then applies this update to the model, typically by using some form of gradient descent.

Current machine learning approaches require the availability of large datasets, which are usually created by collecting huge amounts of data from user or client computing devices. Federated learning is a more flexible technique that allows training a model without directly seeing the data. Although the machine learning process is used in a distributed way, federated learning is quite different to the way conventional machine learning is used in data centers. The local data used in federated learning may not have the same guarantees about data distributions as in traditional machine learning processes, and communication is oftentimes slow and unstable between the local users or client computing devices and the server node or computing device. To be able to perform federated learning efficiently, proper optimization processes need to be adapted within each user machine or computing device. For instance, different telecommunications operators will each generate huge alarm datasets and relevant features. In this situation, there may be a good list of false alarms compared to the list of true alarms. For such a machine learning classification task, typically, the dataset of all operators in a central hub/repository would be required beforehand. This is required since different operators will encompass a variety of features, and the resultant model will learn their characteristics. However, this scenario is extremely impractical in real-time since it requires multiple regulatory and geographical permissions; and, moreover, it is extremely privacy-invasive for the operators. The operators often will not want to share their customers' data out of their premises. Hence, distributed machine learning, such as federated learning, may provide a suitable alternative that can be leveraged to greater benefit in such circumstances.

### SUMMARY

In federated learning (FL), it is usually assumed the many millions of users will participate in the entire process. However, every user cannot have new data at every iteration and, also because of other requirements, only some of these million users will participate in a single FL iteration. If we consider only these small subset user updates to update the global ML model, it may lead to a poor global generic ML model. Embodiments disclosed herein provide a new statistical way of averaging the updates by extrapolating the user's information from the available user's information. Methods disclosed herein enable the generation of a better global generic model, for example, as applied to internet of senses data.

The concept of internet of senses involves technology interacting with our senses of sight, sound, taste, smell and touch, enabled by Artificial Intelligence, Virtual Reality/Augmented Reality, 5G and automation. Researchers have created a new chipset to capture user's senses through IoT devices and replicate the process. Main drivers for the Internet of senses include immersive entertainment and online shopping, the climate crisis and the corresponding need to minimize climate impact.

In embodiments disclosed herein, since different sensors inputs relating to senses will be extrapolated, it is possible to arrive at a suitable solution. The derived statistical extracts will enable providing a best solution with limited samples in mission critical systems or establishing human-computer interface (HCl) in ubiquitous computing.

Federated learning deals with combining multiple local models into a single global model in the cloud. In traditional federated learning, a normal averaging method is used to train the global model. In recent papers-see, e.g., Joohyung, Jeon & Park, Soohyun & Choi, Minseok & Kim, Joongheon & Kwon, Young-Bin & Cho, Sungrae. (2020). Optimal User Selection for High-Performance and Stabilized Energy-Efficient Federated Learning Platforms. Electronics; and Nishio, Takayuki & Yonetani, Ryo. (2019). Client Selection for Federated Learning with Heterogeneous Resources in Mobile Edge. 1-7. 10.1109/ICC.2019.8761315—, authors tend to use some weighted averaging methods to train the global model. However, there are some problems with the usage of traditional averaging.

Federated learning (FL) may, in some situations, involve many numbers of users participating in an iteration so that the global model is not biased. However, in several situations, there may be a limited, small number of users participating in a single FL iteration. In this case, the global model is biased over a limited number of users and may not be generic enough to explain the data of other users.

Since the number of users who will participate in a single FL iteration changes, the model learnings in the subsequent iterations will get affected. Embodiments disclosed herein provide for extrapolating the learnings of local models participating in a single FL iteration to arrive at better global model. Embodiments disclosed herein provide a new approach to obtain a generic model of all the users even when some small subset of the users participated in the FL iteration. The idea is to statistically average all the model updates of local users and to arrive at a generic global model.

In some embodiments disclosed herein provide a new averaging technique in FL which can result in a good generic model. The new averaging technique can extrapolate the information of the users who do not participate in a specific iteration. By using this method, the global model is not biased and can result in a good accurate model. Embodiments disclosed herein find specific application in Internet of Senses use cases where the sample features may differ and induce biases to the model.

In general, some embodiments disclosed herein provide for doing an extrapolation of the information of subset number of users (M) by constructing a probability distribution of weights of all the local models. Further, from the constructed probability distribution we randomly sample model weights for all the local users participated (N, M<<N) that would have participated in the FL iteration. In this way, we can extrapolate information of all the users present in FL framework from the users who sent the local models in a single iteration.

One advantage with this approach is that the global model is not biased even when there are lesser number of users participated in FL iteration. Also, since the users who participate in every FL iteration changes, the global model will not be biased to some of the users. Another advantage is that the global model obtained will be generic and has information about all the local users even though the information about missing users is not available. In this way, we can obtain generic global model.

In some embodiments disclosed herein provide a new averaging technique which can result in obtaining a generic global model even when a lesser number of users participated in a single FL iteration. Embodiments disclosed herein use a statistical exploration technique to come with representative local models for all the local users (e.g., mobile phones).

In some embodiments disclosed herein can also advantageously obtain a generic global model even when some minimal number of users participated in a single FL iteration. The global model will not be biased even when lesser number of users are participating in a single FL iteration. The computational time of the proposed method is not higher when compared with existing methods.

In some embodiments disclosed herein can be applied to the new area of IoT like “Internet of senses” to derive a solution based on various sensing values. The sensing values are volatile and sample features may vary with less frequencies. Applying the statistical FL technique of the embodiments disclosed herein to internet of senses data, it is possible to derive a best solution. Embodiments disclosed herein enable achieving a faster and better solution in Mission Critical systems and HCl applications.

According to a first aspect, a method for distributed machine learning (ML) at a central computing device is provided. The method includes providing a global ML model to a plurality of local computing devices, wherein the global ML model includes a plurality of parameters. The method further includes receiving, from each local computing device in a subset of the plurality of local computing devices, a local ML model updated based on the global ML model, wherein the local ML model includes weights with values corresponding to one or more of the plurality of parameters. The method further includes constructing, for each weight value in each of the received local ML models, a probability distribution for each of the plurality of parameters with corresponding received weight values. The method further includes sampling, using the constructed probability distribution for each weight value for each of the plurality of parameters, for all of the plurality of local computing devices to generate representative values for each weight. The method further includes updating the global ML model by averaging the representative values for each weight for each of the plurality of parameters.

In some embodiments, after updating the global ML model, the steps of the method are repeated for a predetermined number of iterations i. In some embodiments, the global ML model is one or a combination of: a convolutional neural network (CNN), a artificial neural network (ANN), and a recurrent neural network (RNN).

In some embodiments, the plurality of parameters and weights correspond to an alarm dataset for a telecommunications operator, and the global ML model is a classifier-type model that classifies alarms as either a true alarm or a false alarm. In some embodiments, the plurality of parameters and weights correspond to an internet of senses dataset for one of: sight, sound, taste, smell and touch sensations, and the global ML model is a classifier-type model that classifies sensations. In some embodiments, the plurality of parameters and weights correspond to an internet of senses dataset for taste sensations and the global ML model is a classifier-type model that classifies taste sensations as being from one to all five of the basic taste sensations.

In some embodiments, the method further includes providing the updated global ML model to the plurality of local computing devices. In some embodiments, the plurality of local computing devices comprises a plurality of radio network nodes which are configured to classify an alarm type using the updated global ML model. In some embodiments, the plurality of local computing devices comprises a plurality of wireless sensor devices which are configured to classify an alarm type using the updated Global ML model. In some embodiments, the plurality of local computing devices comprises a plurality of radio network nodes which are configured to classify internet of senses sensations using the updated global ML model. In some embodiments, the plurality of local computing devices comprises a plurality of wireless sensor devices which are configured to classify internet of senses sensations using the updated Global ML model.

According to a second aspect, a central computing device is provided. The central computing device includes a memory and a processor coupled to the memory. The processor is configured to provide a global ML model to a plurality of local computing devices, wherein the global ML model includes a plurality of parameters. The processor is further configured to receive, from each local computing device in a subset of the plurality of local computing devices, a local ML model, wherein the local ML model includes weights with values corresponding to one or more of the plurality of parameters. The processor is further configured to construct, for each weight value in each of the received local ML models, a probability distribution for each of the plurality of parameters with corresponding received weight values. The processor is further configured to sample, using the constructed probability distribution for each weight value for each of the plurality of parameters, for all of the plurality of local computing devices to generate representative values for each weight. The processor is further configured to update the global ML model by averaging the representative values for each weight for each of the plurality of parameters.

In some embodiments, after updating the global ML model, the steps of the method are repeated for a predetermined number of iterations i. In some embodiments, the global ML model is one or a combination of: a convolutional neural network (CNN), a artificial neural network (ANN), and a recurrent neural network (RNN).

In some embodiments, the plurality of parameters and weights correspond to an alarm dataset for a telecommunications operator, and the global ML model is a classifier-type model that classifies alarms as either a true alarm or a false alarm. In some embodiments, the plurality of parameters and weights correspond to an internet of senses dataset for one of: sight, sound, taste, smell and touch sensations, and the global ML model is a classifier-type model that classifies sensations. In some embodiments, the plurality of parameters and weights correspond to an internet of senses dataset for taste sensations and the global ML model is a classifier-type model that classifies taste sensations as being from one to all five of the basic taste sensations.

In some embodiments, the processor is further configured to provide the updated global ML model to the plurality of local computing devices. In some embodiments, the plurality of local computing devices comprises a plurality of radio network nodes which are configured to classify an alarm type using the updated global ML model. In some embodiments, the plurality of local computing devices comprises a plurality of wireless sensor devices which are configured to classify an alarm type using the updated global ML model. In some embodiments, the plurality of local computing devices comprises a plurality of radio network nodes which are configured to classify internet of senses sensations using the updated global ML model. In some embodiments, the plurality of local computing devices comprises a plurality of wireless sensor devices which are configured to classify internet of senses sensations using the updated global ML model.

According to a third aspect, a computer program is provided comprising instructions which when executed by processing circuitry causes the processing circuitry to perform the method of any one of the embodiments of the first aspect.

According to a fourth aspect, a carrier is provided containing the computer program of the third aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a federated learning system according to an embodiment.

FIG. 2 illustrates a federated learning system according to an embodiment.

FIG. 3 illustrates a message diagram according to an embodiment.

FIG. 4 is a flow chart illustrating a process according to an embodiment.

FIG. 5 is a graph illustrating the final accuracies for the local models of 5 users trained using the traditional averaging federated learning method.

FIG. 6 is a graph illustrating the final accuracies for the local models of 5 users trained using the statistical federated learning method according to an embodiment.

FIG. 7 is a block diagram of an apparatus according to an embodiment.

FIG. 8 is a block diagram of an apparatus according to an embodiment.

### DETAILED DESCRIPTION

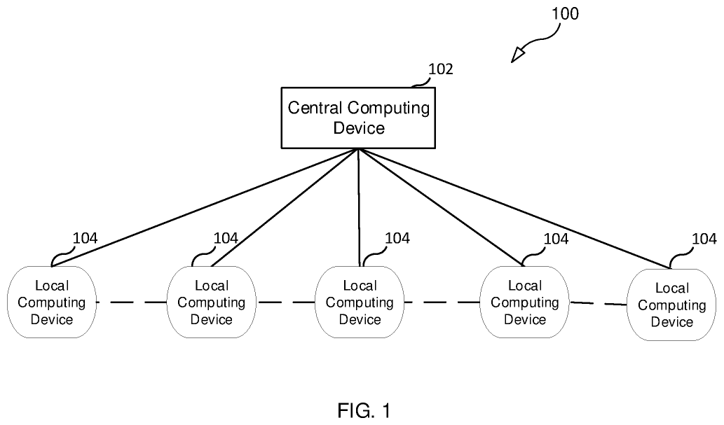

FIG. 1 illustrates a system 100 of federated learning according to an embodiment. As shown, a central computing device 102 is in communication with one or more local computing devices 104. As described in further detail herein, in some embodiments, a local client or user is associated with a local computing device 104, and a global user is associated with a central server or computing device 102. In some embodiments, local computing devices 104 or local users may be in communication with each other utilizing any of a variety of network topologies and/or network communication systems. In some embodiments, central computing device 102 may include a server device, cloud server or the like. In some embodiments, local computing devices 104 may include user devices or user equipment (UE), such as a smart phone, tablet, laptop, personal computer, and so on, and may also be communicatively coupled through a common network, such as the Internet (e.g., via WiFi) or a communications network (e.g., LTE or 5G). While a central computing device is shown, the functionality of central computing device 102 may be distributed across multiple nodes, computing devices and/or servers, and may be shared between one or more of the local computing devices 104.

Federated learning as described in embodiments herein may involve one or more rounds, where a global ML model is iteratively trained in each round. Local computing devices 104 may register with the central computing device 102 to indicate their willingness to participate in the federated learning of the global ML model and may do so continuously or on a rolling basis. Upon registration (and potentially at any time thereafter), the central computing device 102 may select a ML model type and/or ML model architecture for the local computing device to train. Alternatively, or in addition, the central computing device 102 may allow each local computing device 104 to select a ML model type and/or ML model architecture for itself. The central computing device 102 may transmit an initial ML model to the local users 104. For example, the central computing device 102 may transmit to the local users 104 a global ML model (e.g., newly initialized or partially trained through previous rounds of federated learning). The local users 104 may train their individual ML models locally with their own data. The results of such local training may then be reported back to central computing device 102, which may pool the results and update the global ML model. This process may be repeated iteratively. Further, at each round of training the global ML model, central computing device 102 may select a subset of all registered local users 104 (e.g., a random subset) to participate in the training round.

To demonstrate the general scenario of statistically extrapolating information in a federated learning (FL) setting in accordance with embodiments disclosed herein, let N be the total users participating in a FL way to arrive at global ML model. Assume in any of the iterations only M<<N users participate in updating the global ML model. This is normal case as only some of the users participating meet the requirements in any FL iteration. These requirements include having enough data, power status, etc. In this case, if we update the global ML model using the ML model updates of only M users, this can create a global ML model biased to these M users. As more and more iterations pass, the global ML model will be much more biased.

In accordance with embodiments disclosed herein, a new way is described to statistically average M local ML models to capture the information of the remaining N-M users to arrive at a global ML model. In an exemplary embodiment:

1. Collect the ML model updates of M users.

2. Construct the distribution of the each of the parameters across the M users.

3. Randomly sample values from the constructed distribution and use it as estimate for the unobserved local user. Random N-M such values from the distribution.

4. From the existing M values and generated N-M values, construct the global ML model.

Repeat steps 1-4 until all FL iterations are finished.

More specifically, assume there are N users participating in a FL framework. The private data with every user is Dᵢⱼ, where ‘i’ is the federated learning iteration and ‘j’ is the user index, which is j=1, . . . , N. In a federated learning scenario, the output of the local ML models can be expressed as f(θᵢⱼ, Dᵢⱼ), which is the function of parameters which are computed using the iteration of the local, private data.

Assume the initial global ML model developed is supplied by global user G₀, and that there are N users present in the FL framework.

### First Iteration

The global ML model G₀ is provided to all the N local users and a request is made to the N local users for them to update the ML model. However, only some subset of the N local users will participate in a FL iteration. The subset of users that participate in an FL iteration will be of length M (where M<<N). Each user in the subset M users will update the ML model using the data Dᵢⱼ, where j∈{M}.

Each user of this M subset will update the ML model using their private data D₁ⱼ and compute the ML model as:

$$f ( \frac{{θ}_{1 j}}{{D}_{1 j}} ) ,$$

$$j ∈ M$$

These local ML models are sent from the local computing devices to a central computing device, which is a global user that maintains a global ML model.

### Traditional Federated Learning

In traditional federated learning, at the global user in the central computing device, the received models are averaged to create a new global ML model:

$${G}_{1} = \frac{1}{M} {\sum }_{k = 1}^{M} f ( {θ}_{1 k} / {D}_{1 k} )$$

However, since there is only information available for M users, when the global ML model is updated, the ML model will be biased towards to these M users.

Moreover, in the next iterations, since the same or different M users can contribute to the global ML model, the ML model learnings can be entirely different, and will result in a poor global ML model. In this case, the traditional federated learning averaging methods, or similar methods, do not work.

### Statistical Federated Learning

In accordance with embodiments disclosed herein, after receiving the local ML models from the local computing devices for each user M of the subset, a probability distribution for each weight in the local ML models is constructed. For example, assume there is a first weight in the first layer, first neuron. Construct a probability distribution for this weight and let it be fₜ. Then construct probability distributions for each weight in the local ML model in each layer for each local computing device—i.e., each of the M users.

Using the constructed probability distribution fₜ, randomly sample N values as representative values for all of the N users in the federated learning framework. This sampling is performed for all the weights in the local ML model, generating N representative values for each weight in the ML model.

The global ML model is updated using the generated N representative values for these weights by averaging:

$${G}_{1} = \frac{1}{N} {\sum }_{k = 1}^{N} {S}_{N} ( {f}_{t} ) ,$$

$$t = 1 , … , W$$

W is the total number of weights in the ML model, Sp is the sampling operation which will sample N samples.

### Subsequent Iterations

This same approach, as just described, can be used for all subsequent iterations, which will result in a global ML model that is not poor, unbiased, and generic, notwithstanding that some local users do not participate in the iterations. Embodiments disclosed herein enable the formation of a global ML model that is generic and unbiased, that can be used as a faster and better solution in, for example, mission critical systems and for human-computer interaction (HCl).

### Exemplary Algorithm

```
Algorithm
Input: N Users to participate in FL framework, Initial global ML model
G₀, I iterations in FL framework
Output: Final Global ML model G_{M}
Begin
for i in 1:I (Iterations loop)
  send global ML model Gᵢ₋₁ to all the N users
  for every iteration i, sample M random number of users to update the
  global ML model collect the ML model updates for these M users on
  a special node in the global user [assume there are W parameters
  in the global ML model] for each weight in the M updated ML
  models,
    construct the probability distribution for each of the W
    parameters with values from these M updated ML models
  for each parameter, use the sample N values from the constructed
  probability distribution S_{N}(fₚ), p = 1, . . . . , W
  compute new global ML model as:
        ${G}_{i} = \frac{1}{N} {\sum }_{k = 1}^{N} {S}_{N} ( {f}_{t} ) , t = 1 , … … … , W$
Repeat until I iterations
End
```

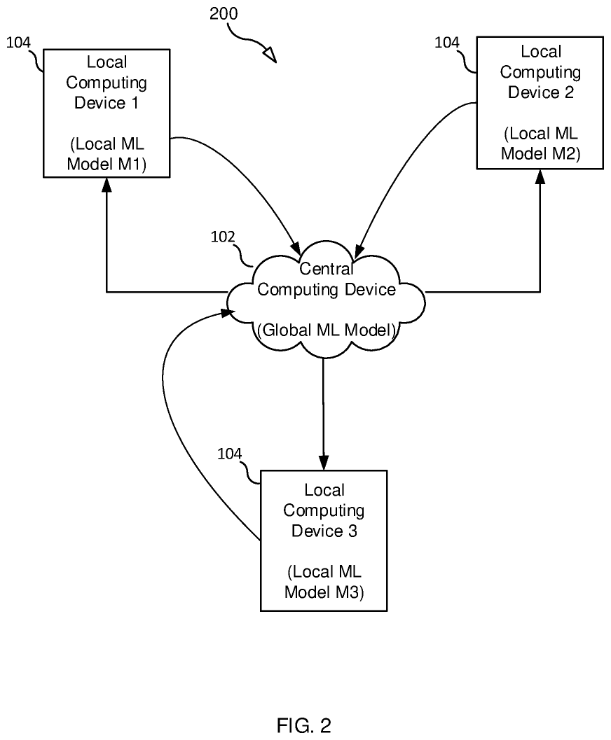

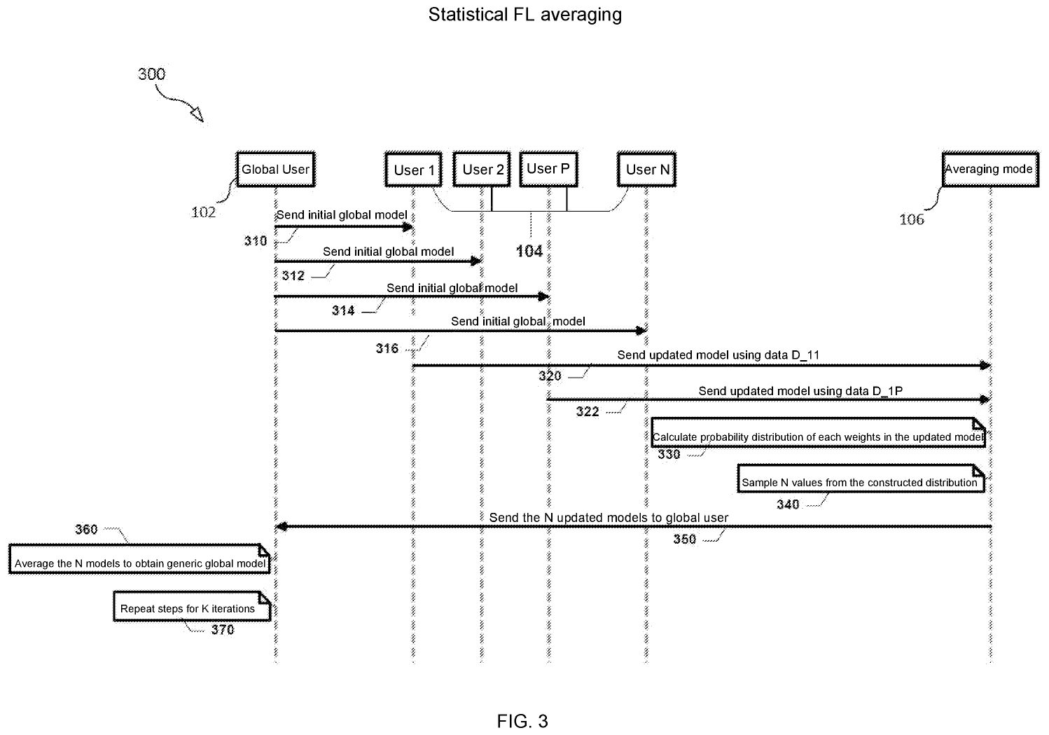

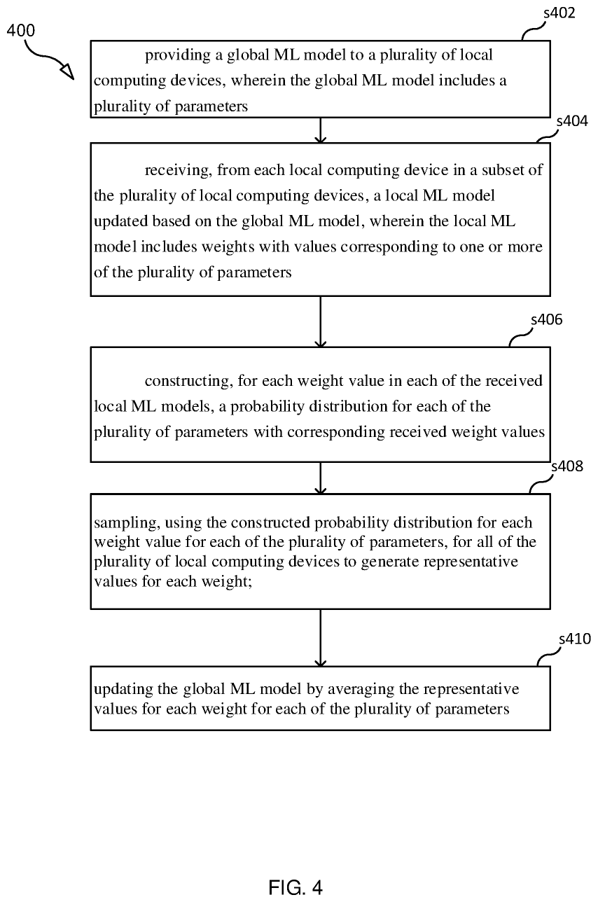

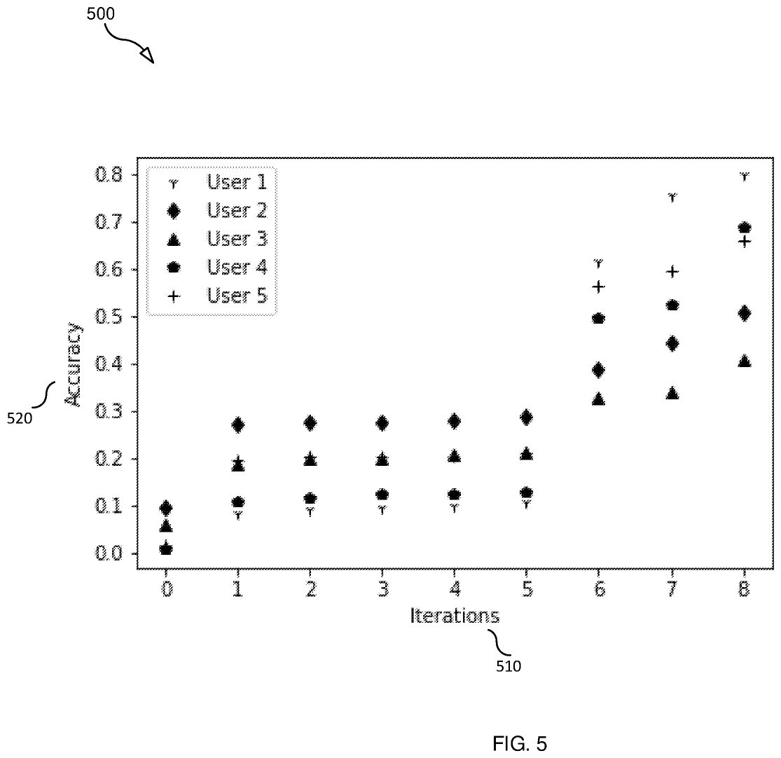

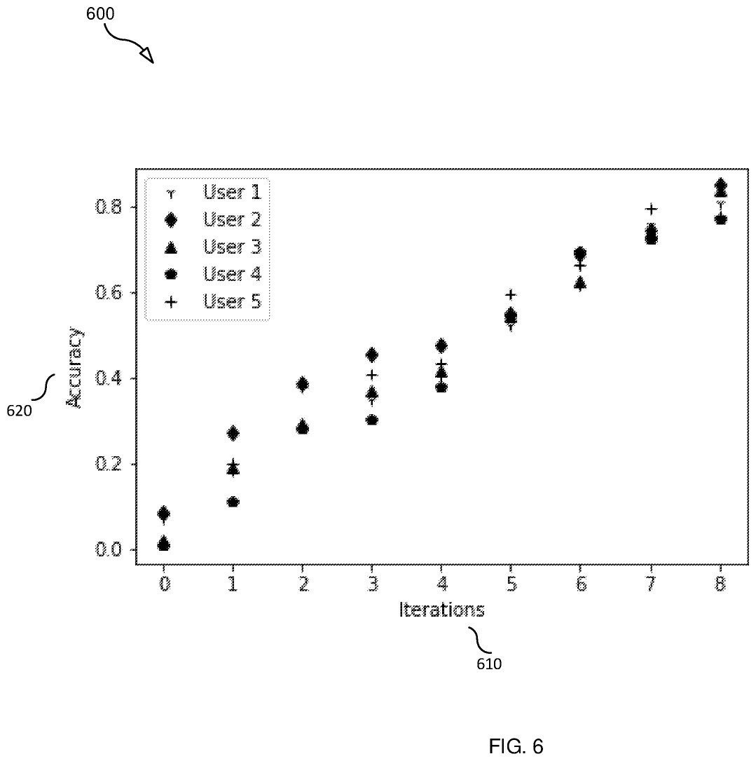

Application of the forgoing method for statistically extrapolating information in a federated learning (FL) framework, and the exemplary algorithm provided, are further discussed with reference to FIG. 2, FIG. 3, FIG. 4, FIG. 5, and FIG. 6.

FIG. 2 illustrates a system 200 according to some embodiments. System 200 includes three users 104, labeled as “Local Computing Device 1”, “Local Computing Device 2”, and “Local Computing Device 3”. Each of the Users, Local Computing Devices 104, include a Local ML Model. User 1, Local Computing Device 1 includes Local ML Model M1; User 2, Local Computing Device 2 includes Local ML Model M2; and User 3, Local Computing Device 3 includes Local ML Model M3.

System 200 also includes a Central Computing Device 102, which includes a Global ML Model. The Global ML Mode and each of the Local ML Models M1, M2, and M3 may be one or a combination of the following model types: a convolutional neural network (CNN), a artificial neural network (ANN), and a recurrent neural network (RNN).

As shown, there are three different local devices. Interaction happens between a central global ML model, which exists in the central computing device 102, and the users are local computing devices 104, e.g., configurations with embedded systems or mobile phones. A global ML model and local ML models are transferred for training and updating from/to a global user of a central computing device 102 and local users of local computing devices 104.

Local computing devices 104 are capable of running on a low-resource constrained device, such as, for example, one having ˜256 MB RAM. This makes the federated learning methods according to embodiments described herein suitable for running on many types of local client computing devices, including contemporary mobile/embedded devices such as smartphones. Advantageously, the federated learning methods according to embodiments described herein are not computationally intensive for local users and local computing devices and can be implemented in low-power constrained devices.

### Exemplary Embodiments

As an example, let us assume there are 1000 users participating in a FL framework. Out of these 1000 users, assume only 100 users will participate in a single FL iteration. If the global ML model is updated using these 100 user's information, it may lead to a poor generic global ML model that is, for example, biased. In addition, these 100 users will change with subsequent iterations, which may also lead to a poor updated global ML model.

In an exemplary embodiment, these 100 ML model updates from these 100 users who participate in a single FL iteration are received by a central computing device, which maintains the global ML model. A probability distribution is constructed for each participating weight in the received model updates for the 100 users. Assume there are two weights in each ML model update. In that case, there are 100 different values corresponding to these 2 weight parameters. Two probability distributions are constructed for each of the weight parameters in the ML model.

In the exemplary embodiment, information on the 900 users that did not participate in the FL iteration is obtained by sampling, using the two probability distributions constructed for each of the weight parameters in the ML model, for all of the 1000 user's values for the two different weight parameters. In this way, information can be extrapolated for all the missing users in the corresponding iteration to all the users presented in FL framework, and that additional information for the missing users is added to the global ML model.

FIG. 3 illustrates a message diagram 300 according to an embodiment. Local users or client computing devices 104 (User 1, User 2, User P, and User N are shown) and a global user or central computing device 102 communicate with each other. An Averaging node 106 communicates with one or more Local users or client computing devices 104 and the Global User or central computing device 102. Use of an Averaging node 106 is optional, and the steps performed by the Averaging node 106 may be carried out by the central computing device 102.

The Global User/central computing device 102 first provides an initial global ML model to each of the Users 1 . . . . N/local computing devices 104 at 310, 312, 314, and 316. Each of the Users 1 . . . . N/local computing devices 104 have a local ML model. As described above with reference to FIG. 2 and below in further detail with reference to FIG. 4, each of the local computing devices 104 use the received global ML model, which includes a plurality of parameters, and their own data, to update their own local ML model, including weights with values corresponding to one of more of the plurality of parameters from the received global ML model. At 320, User 1/local computing device 104 provides its updated local ML model (using data D_11) to averaging node 106. At 322, User P/local computing device 104 provides its updated local ML model (using data D_1P) to averaging node 106.

The averaging node 106, at 330, calculates, for each weight value in each of the received local ML models, a probability distribution for each of the plurality of parameters with corresponding received weight values. At 340, the averaging node samples, using the constructed probability distribution for each weight value for each of the plurality of parameters, for all of the plurality of local computing devices and generates representative values for each weight. At 350, the averaging node 106 provides the N updated ML models, including the representative values for each weight, to the global user/central computing device 102.

The global user/central computing device 102, at 360, updates the global ML model by averaging the representative values for each weight for each of the plurality of parameters. As indicated at 370, the steps 310 to 360 are repeated for K iterations.

FIG. 4 illustrates a flow chart according to an embodiment. Process 400 is a method for distributed machine learning (ML) at a central computing device. Process 400 may begin with step s402.

Step s402 comprises providing a global ML model to a plurality of local computing devices, wherein the global ML model includes a plurality of parameters.

Step s404 comprises receiving, from each local computing device in a subset of the plurality of local computing devices, a local ML model updated based on the global ML model, wherein the local ML model includes weights with values corresponding to one or more of the plurality of parameters.

Step s406 comprises constructing, for each weight value in each of the received local ML models, a probability distribution for each of the plurality of parameters with corresponding received weight values.

Step s408 comprises sampling, using the constructed probability distribution for each weight value for each of the plurality of parameters, for all of the plurality of local computing devices to generate representative values for each weight.

Step s410 comprises updating the global ML model by averaging the representative values for each weight for each of the plurality of parameters.

After updating the global ML model, step s410, steps s402 to s410 of the method are repeated for a predetermined number of iterations i.

In some embodiments, updating of each of the received local ML models based on the global ML model is according to:

$$f ( \frac{{θ}_{ij}}{{D}_{ij}} ) ,$$

$$j ∈ M ,$$

where
N is the number of local computing devices;
M is the number of local computing devices in the subset;
i is the number of iterations;
j is the index of the number of local computing devices 1, . . . , N
θᵢⱼ is the weights obtained at i^{th} iteration for j^{th} local computing device;
Dᵢⱼ is the private data of j^{th} local computing device at i^{th} iteration; and

$$f ( \frac{{θ}_{1 j}}{{D}_{1 j}} )$$

is the model obtained for j^{th} local computing device at i^{th} iteration.

In some embodiments, the constructed probability distribution for each weight value for each of the plurality of parameters is according to:

S_{N}(fₚ), p=1, . . . ,W, where
W is the total number of weights in the global ML model;
S_{N} is the function for sampling the N local computing devices; and
fₚ is the constructed probability distribution for each weight value for each of the plurality of parameters.

In some embodiments, updating the global ML model by averaging the representative values for each weight for each of the plurality of parameters is according to:

$${G}_{1} = \frac{1}{N} {\sum }_{K = 1}^{N} {S}_{N} ( {f}_{t} ) ,$$

$$t = 1 , … , W ,$$

G₁ is the updated global ML model;
W is the total number of weights in the global ML model;
S_{N} is the function for sampling the N local computing devices; and
fₜ is the constructed probability distribution for each weight value for each of the plurality of parameters.

In some embodiments, the global ML model is one or a combination of: a convolutional neural network (CNN), a artificial neural network (ANN), and a recurrent neural network (RNN).

In some embodiments, the plurality of parameters and weights correspond to an alarm dataset for a telecommunications operator, and the global ML model is a classifier-type model that classifies alarms as either a true alarm or a false alarm.

In some embodiments, the plurality of parameters and weights correspond to an internet of senses dataset for one of: sight, sound, taste, smell and touch sensations, and the global ML model is a classifier-type model that classifies sensations.

In some embodiments, the plurality of parameters and weights correspond to an internet of senses dataset for taste sensations and the global ML model is a classifier-type model that classifies taste sensations as being from one to all five of the basic taste sensations.

In some embodiments, the plurality of local computing devices comprises a plurality of radio network nodes which are configured to classify an alarm type using the updated global ML model. In some embodiments, the plurality of local computing devices comprises a plurality of wireless sensor devices which are configured to classify an alarm type using the updated global ML model.

In some embodiments, the plurality of local computing devices comprises a plurality of radio network nodes which are configured to classify internet of senses sensations using the updated global ML model. In some embodiments, the plurality of local computing devices comprises a plurality of wireless sensor devices which are configured to classify internet of senses sensations using the updated global ML model.

The following is an example of the application, for telecom alarm data, of the statistical extrapolation of information in federated learning according to some embodiments. Alarm datasets corresponding to five operators are used. It is assumed that the objective is classification and, more specifically, to classify the data into five labels {l₁, l₂, l₃, l₄, l₅}. Here, the objective is to classify the alarm types based on their respective features. Out of these five operators, we assume there are randomly 3 or 4 operators that participate in a FL iteration.

The model architecture of the global model is chosen to be a three-layer CNN with 32, 64 and 32 filters. In all of these examples, it should be noted that we trained a Gaussian distribution for the weights in the data. In several cases, the distribution is Gaussian and one can expect also other distribution shapes. In such cases, one can manually see the distribution and identify the shape of distribution.

The final average accuracies obtained if we use traditional averaging for the three local ML models are: 80%, 51%, 41%, 69%, and 66%. The final accuracies obtained at the three local ML models when using the method of the embodiments disclosed herein are: 81%, 85%, 84%, 77%, and 78%. The federated learning ML model using the methods of the embodiments disclosed herein is effective and yields better results, when compared to the local ML models operating by themselves. The ML model was run for 50 iterations, and these accuracies were reported across three different experimental trials, and averaged.

FIG. 5 is a graph illustrating the final accuracies, from the example for the telecom alarm data, for the local ML models of 5 users trained using the traditional averaging federated learning method. More specifically, the graph of FIG. 5 illustrates the final accuracies for the local ML models of 5 users for a federated learning iteration in which three (3) users participate using the traditional averaging method. The x-axis 510 in the graph represents the number of iterations in FL—i.e. the number of times the global ML model is updated with the local user's data. The y-axis 520 in the graph represents the accuracy of the local ML models of the 5 users after each update of the global ML model.

FIG. 6 is a graph illustrating the final accuracies, from the example for the telecom alarm data, for the local ML models of 5 users trained using the statistical federated learning method according to an embodiment. More specifically, the graph of FIG. 6 illustrates the final accuracies for the local ML models of 5 users for a federated learning iteration in which three (3) users participate using the method of the embodiments disclosed herein. The x-axis 610 in the graph represents the number of iterations in FL—i.e. the number of times the global ML model is updated with the local user's data. The y-axis 620 in the graph represents the accuracy of the local ML models of the 5 users after each update of the global ML model.

As described above for the example for the telecom alarm data, and as illustrated in the graphs of FIG. 5 as compared with FIG. 6, the federated learning ML model using the methods of the embodiments disclosed herein is effective and yields better results, when compared to the local ML models operating by themselves.

The following is another example of the application, in this case for the internet of senses, of the statistical extrapolation of information in federated learning according to some embodiments. Internet of senses is one of the new areas in IoT where we need to approximate the values based on a certain group of users due to non-availability or noise. It also involves transferring the personal information (regarding the sensor information) of users. In this case, we generally prefer going to a federated learning approach for data privacy, since this does not require transferring of private data and the users can learn other user's features without using the data. By using the method described herein, a generic model can be obtained.

The internet of senses example herein relates to taste. Research on electric taste in the HCl field has grown in popularity ever since Nakamura et al. proposed the idea of “Augmented Gustation,”-see Hiromi Nakamura, Homei Miyashita. 2011. Augmented Gustation using Electricity. In Proceedings of the 2nd Augmented Human International Conference (AH2011), 34:1-2. https://doi org/10.1145/1959826_1959860—in which the taste of food and drinks is altered by chopsticks and straws that conduct electricity. Another study—Homei Miyashita. Norimaki Synthesizer: Taste Display Using Ion Electrophoresis in Five Gels. CHI 2020 Extended Abstracts, Apr. 25-30, 2020, Honolulu, HI, USA—describes the production of a novel taste display which uses ion electrophoresis in five gels containing electrolytes that supply controlled amounts of each of the five basic tastes to apply an arbitrary taste to the user's tongue. When applied to the tongue with no voltage, the user can taste all five tastes. However, when an electric potential is applied, the cations in the gel move to the cathode side and away from the tongue, so that the flavor is tasted weakly. In this way, this synthesizer developed a taste display that reproduces an arbitrary taste by individually suppressing the sensation of each of the five basic tastes (like subtractive synthesis.)

In this experiment, we can test with different samples and only very few samples show different features compare to the global model. Here we can apply our approach to exactly bring out the correct mixture for specific samples to generate an arbitrary taste to the user's tongue. However, since this requires large number samples to participate in FL framework. However, as we mentioned only some of the users may participate in a single FL iteration owing to large number of users. By using the proposed approach, we can limit the samples to arrive a good global generic ML model even when so many users missing in a single FL iteration to generate an arbitrary taste by suppressing the sensation of each of the five basic tastes

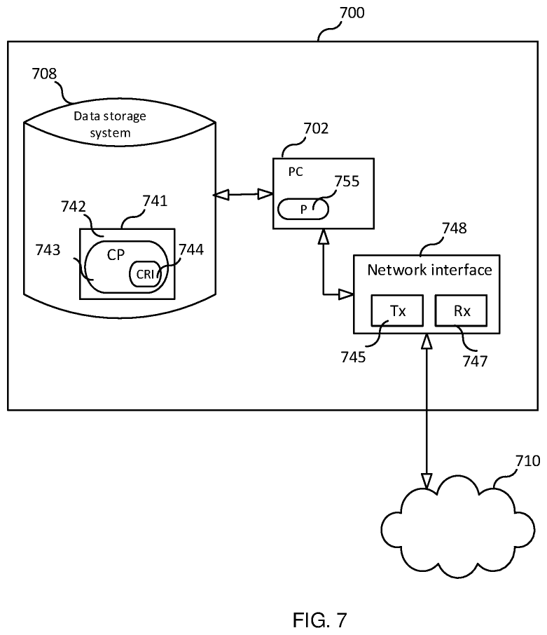

FIG. 7 is a block diagram of an apparatus 700 (e.g., a local computing device 104 and/or central computing device 102), according to some embodiments. As shown in FIG. 7, the apparatus may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like); a network interface 748 comprising a transmitter (Tx) 745 and a receiver (Rx) 747 for enabling the apparatus to transmit data to and receive data from other computing devices connected to a network 710 (e.g., an Internet Protocol (IP) network) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the apparatus to perform steps described herein (e.g., steps described herein with reference to the flow charts). In other embodiments, the apparatus may be configured to perform steps described herein without the need for code. That is, for example, PC 702 may consist merely of one or more ASICs. Hence, the features of the embodiments described herein may be implemented in hardware and/or software.

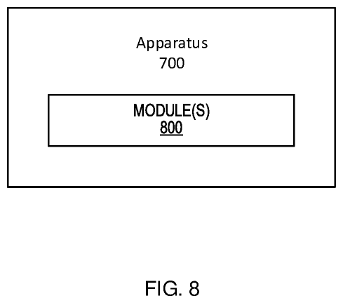

FIG. 8 is a schematic block diagram of the apparatus 700 according to some other embodiments. The apparatus 700 includes one or more modules 800, each of which is implemented in software. The module(s) 800 provide the functionality of apparatus 700 described herein (e.g., the steps herein, e.g., with respect to FIGS. 2, 3, and 4).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for distributed machine learning (ML) at a central computing device, the method comprising:
providing a global ML model to a plurality of local computing devices, wherein the global ML model includes a plurality of parameters;
receiving, from each local computing device in a subset of the plurality of local computing devices, a local ML model updated based on the global ML model, wherein the local ML model includes weights with values corresponding to one or more of the plurality of parameters;
constructing, for each weight value in each of the received local ML models, a probability distribution for each of the plurality of parameters with corresponding received weight values;
sampling, using the constructed probability distribution for each weight value for each of the plurality of parameters, for all of the plurality of local computing devices to generate representative values for each weight; and
updating the global ML model by averaging the representative values for each weight for each of the plurality of parameters.

2. The method according to claim 1, wherein, after updating the global ML model, the steps of the method are repeated for a predetermined number of iterations i.

3. The method according to claim 2, wherein updating of each of the received local ML models based on the global ML model is according to:
$$f ( \frac{{θ}_{ij}}{{D}_{ij}} ) ,$$
$$j ∈ M ,$$
where
N is the number of local computing devices;
M is the number of local computing devices in the subset;
i is the number of iterations;
j is the index of the number of local computing devices 1, . . . , N
θᵢⱼ is the weights obtained at i^{th} iteration for j^{th} local computing device;
Dᵢⱼ is the private data of j^{th} local computing device at i^{th} iteration; and
$$f ( \frac{{θ}_{1 j}}{{D}_{1 j}} )$$
is the model obtained for j^{th} local computing device at i^{th} iteration.

4. The method according to claim 3, wherein the constructed probability distribution for each weight value for each of the plurality of parameters is according to:
S_{N}(fₚ), p=1, . . . ,W, where
W is the total number of weights in the global ML model;
S_{N} is the function for sampling the N local computing devices; and
fₚ is the constructed probability distribution for each weight value for each of the plurality of parameters.

5. The method according to claim 4, wherein updating the global ML model by averaging the representative values for each weight for each of the plurality of parameters is according to:
$${G}_{1} = \frac{1}{N} {\sum }_{K = 1}^{N} {S}_{N} ( {f}_{t} ) ,$$
$$t = 1 , … , W ,$$
where
G₁ is the updated global ML model;
W is the total number of weights in the global ML model;
S_{N} is the function for sampling the N local computing devices; and
fₜ is the constructed probability distribution for each weight value for each of the plurality of parameters.

6. The method according to claim 1, wherein the global ML model is one or a combination of: a convolutional neural network (CNN), a artificial neural network (ANN), and a recurrent neural network (RNN).

7. The method according to claim 1, wherein the plurality of parameters and weights correspond to an alarm dataset for a telecommunications operator, and the global ML model is a classifier-type model that classifies alarms as either a true alarm or a false alarm.

8. The method according to claim 1, wherein the plurality of parameters and weights correspond to an internet of senses dataset for one of: sight, sound, taste, smell and touch sensations, and the global ML model is a classifier-type model that classifies sensations.

9. The method according to claim 8, wherein the plurality of parameters and weights correspond to an internet of senses dataset for taste sensations and the global ML model is a classifier-type model that classifies taste sensations as being from one to all five of the basic taste sensations.

10. The method according to claim 1, further comprising providing the updated global ML model to the plurality of local computing devices.

11. The method according to claim 10, wherein the plurality of local computing devices comprises a plurality of radio network nodes which are configured to classify an alarm type using the updated global ML model.

12. The method according to claim 10, wherein the plurality of local computing devices comprises a plurality of wireless sensor devices which are configured to classify an alarm type using the updated global ML model.

13. The method according to claim 10, wherein the plurality of local computing devices comprises a plurality of radio network nodes which are configured to classify internet of senses sensations using the updated global ML model.

14. The method according to claim 10, wherein the plurality of local computing devices comprises a plurality of wireless sensor devices which are configured to classify internet of senses sensations using the updated global ML model.

15. A central computing device comprising:
a memory; and
a processor coupled to the memory, wherein the processor is configured to:
provide a global ML model to a plurality of local computing devices, wherein the global ML model includes a plurality of parameters;
receive, from each local computing device in a subset of the plurality of local computing devices, a local ML model, wherein the local ML model includes weights with values corresponding to one or more of the plurality of parameters;
construct, for each weight value in each of the received local ML models, a probability distribution for each of the plurality of parameters with corresponding received weight values;
sample, using the constructed probability distribution for each weight value for each of the plurality of parameters, for all of the plurality of local computing devices to generate representative values for each weight; and
update the global ML model by averaging the representative values for each weight for each of the plurality of parameters.

16. The device according to claim 15, wherein the processor is configured to, after updating the global ML model, repeat the steps for a predetermined number of iterations i.

17. The device according to claim 16, wherein updating of each of the received local ML models based on the global ML model is according to:
$$f ( \frac{{θ}_{1 j}}{{D}_{1 j}} ) ,$$
$$j ∈ M ,$$
where
N is the number of local computing devices;
M is the number of local computing devices in the subset;
i is the number of iterations;
j is the index of the number of local computing devices 1, . . . , N
θᵢⱼ is the weights obtained at i^{th} iteration for j^{th} local computing device;
Dᵢⱼ is the private data of j^{th} local computing device at i^{th} iteration; and
$$f ( \frac{{θ}_{1 j}}{{D}_{1 j}} )$$
is the model obtained for j^{th} local computing device at i^{th} iteration.

18. The device according to claim 17, wherein the constructed probability distribution for each weight value for each of the plurality of parameters is according to:
S_{N}(fₚ), p=1, . . . ,W, where
W is the total number of weights in the global ML model;
S_{N} is the function for sampling the N local computing devices; and
fₚ is the constructed probability distribution for each weight value for each of the plurality of parameters.

19. The device according to claim 18, wherein updating the global ML model by averaging the representative values for each weight for each of the plurality of parameters is according to:
$${G}_{1} = \frac{1}{N} {\sum }_{K = 1}^{N} {S}_{N} ( {f}_{t} ) ,$$
$$t = 1 , … , W ,$$
where
G₁ is the updated global ML model;
W is the total number of weights in the global ML model;
S_{N} is the function for sampling the N local computing devices; and
fₜ is the constructed probability distribution for each weight value for each of the plurality of parameters.

20. The device according to claim 15, wherein the global ML model is one or a combination of: a convolutional neural network (CNN), a artificial neural network (ANN), and a recurrent neural network (RNN).

21. The device according to claim 15, wherein the plurality of parameters and weights correspond to an alarm dataset for a telecommunications operator, and the global ML model is a classifier-type model that classifies alarms as either a true alarm or a false alarm.

22. The device according to claim 15, wherein the plurality of parameters and weights correspond to an internet of senses dataset for one of: sight, sound, taste, smell and touch sensations, and the global ML model is a classifier-type model that classifies sensations.

23. The device according to claim 22, wherein the plurality of parameters and weights correspond to an internet of senses dataset for taste sensations and the global ML model is a classifier-type model that classifies taste sensations as being from one to all five of the basic taste sensations.

24. The device according to claim 15, wherein the processor is configured to provide the updated global ML model to the plurality of local computing devices.

25. The device according to claim 24, wherein the plurality of local computing devices comprises a plurality of radio network nodes which are configured to classify an alarm type using the updated global ML model.

26. The device according to claim 24, wherein the plurality of local computing devices comprises a plurality of wireless sensor devices which are configured to classify an alarm type using the updated global ML model.

27. (canceled)

28. The device according to claim 24, wherein the plurality of local computing devices comprises a plurality of radio network nodes which are configured to classify internet of senses sensations using the updated global ML model.

29. The device according to claim 24, wherein the plurality of local computing devices comprises a plurality of wireless sensor devices which are configured to classify internet of senses sensations using the updated global ML model.

30. A computer program product comprising a non-transitory computer readable medium storing a computer program comprising instructions which, when executed by processing circuitry, causes the processing circuitry to perform the method according to claim 1.

31. (canceled)
